(19) United States
(12) Patent Application Publication
(10) Pub. No.: US 2004/0118945 A1
(43) Pub. Date: Jun. 24, 2004

(54) Portable air writing device

(76) Inventor: Paul Grady Russell, Campbell, CA (US)

Correspondence Address: HEWLETT-PACKARD COMPANY, Intellectual Property Administration, P.O. Box 272400, Fort Collins, CO, 80527-2400, US

(21) Appl. No.: 10/324,601

(22) Filed: Dec. 20, 2002

(51) Int. Cl. B05B 7/30

(52) U.S. Cl. 239/346

(57) ABSTRACT

A method for air writing includes creating an airborne field of luminescent particles by using a particle generator connected to a reservoir containing luminescent particles, and tracing a visible path through the field by using a wand to change an intensity of at least some of the airborne particles. The intensity change is effected by causing a chemical reaction to occur at said at least some particles, and may include illumination of dark particles via emission following from light-induced excitation, or quenching of initially illuminated particles. Still other aspects and other features are also described herein.

### BACKGROUND

During presentations, meetings and other group settings, it is often difficult for a presenter to share live handwritten material with the audience. For example, if using traditional media such as black/white boards or flip charts, portions of the audience may be too far away to see. But if the presenter uses text or figures so large that people at the back of the audience can easily see, the presenter may not have enough board or chart space to complete his presentation. In addition, the board or flip chart is often difficult to use in dim or dark environments (for example, where the presenter wishes to simultaneously present a slide show, or outdoors at night). Of course, outdoor environments also present additional difficulties associated with bringing the board or flip chart outdoors.

In order to avoid the large writing/small image problem, presenters sometimes use projectors and screens. For example, an overhead projector allows the presenter to use a handheld marker to write at normal size on a transparency, and the writing is magnified by a projector and displayed on the distant screen. The projector is also helpful in dim or dark environments. However, a projector and screen is cumbersome, and may be especially problematic in outdoors situations. Finally, as with the board/chart, some or all of the projected image may still be blocked by the user's body.

Finally, all of the foregoing is strictly two-dimensional, so that it is difficult to depict depth into the chart, board or projected image. If the presenter is not skilled at perspective drawing, it may not be possible to convey three dimensional information to the audience.

Therefore, it would be useful to have devices and methods to allow a person to write (text, drawings, etc.) in the air without requiring boards, charts, projectors, or other unacceptably cumbersome writing equipment. Furthermore, such an air writing system could provide enhanced presentation capabilities in the form of being able to write in three dimensions.

### SUMMARY

An exemplary method for air writing comprises creating an airborne field of luminescent particles by using a particle generator connected to a reservoir containing luminescent particles, and tracing a visible path through said field by using a wand that changes an intensity of at least some of the airborne particles by causing a chemical reaction at such particles.

A exemplary air writing system comprises: (a) a particle generator configured to create an airborne field of luminescent particles; (b) a source of activating agent for causing a chemical reaction to change a luminance of some of said luminescent particles; and (iii) a handheld wand including an opening for emitting a stream of the particles for causing a chemical reaction, while said wand is used to write in the air.

Other exemplary embodiments and aspects are also disclosed.

### BRIEF DESCRIPTION OF THE FIGURES

FIG. 1 illustrates an exemplary air writing operation.

FIG. 2 illustrates schematically an exemplary generic portable air writing system including an air writing wand having a luminescent particle generator and a source of activating agent.

FIG. 3 illustrates in greater detail an exemplary electromechanical particle generator.

FIG. 4 is a table illustrating exemplary luminescent particles with photonic activating agents.

FIG. 5 illustrates an exemplary luminous charging effect for enhancing luminescence.

FIG. 6 is a table illustrating exemplary chemiluminescent particles and activating agents.

FIG. 7 is a table illustrating exemplary bioluminescent particles and activating agents.

### DETAILED DESCRIPTION

Section I describes properties of luminescence that are usable in connection with an exemplary air writing technology.

Section II describes an exemplary generic air writing system using luminescent substances.

Section III describes an exemplary electromechanical particle generator.

Section IV describes an exemplary air writing system using photons as the activating agent.

Section V describes another exemplary air writing system using chemiluminescent particles, together with corresponding exemplary chemiluminescent activators as the agent for activating the luminescence.

Section VI describes an exemplary chemiluminescent air writing system with quenching.

Section VII describes yet another exemplary embodiment in which the luminescent particles are caused to luminesce within the wand, then written externally.

I. Luminescence

We present various exemplary embodiments of air writing systems that utilize a property of many compounds and other substances, namely the ability to exhibit luminescence when triggered by an activating agent. Luminescence refers to the illumination of an object as a result of a chemical reaction, and substances that are capable of luminescence are referred to as luminescent. Thus, a luminescent substance has at least two states, its non-illuminated state, and its illuminated state.

We shall refer to the chemical reaction as involving luminescent particles and at least one activating agent. The activating agent may be a non-chemical agent, such as photons (i.e., light), or it may be a chemical reagent. Regardless of the type of activating agent, the chemical reaction results in a release of energy that causes the luminescent particle to move from a ground state to an excited state, such that relaxation back to the ground state is accompanied by a release of energy in the form of light. This causes a luminescent particle in an initially non-illuminated state to luminesce, or become illuminated. (Alternatively—as will be described later—still other forms of chemical reaction could cause an initially illuminated luminescent particle to increase its luminescence, or cause its luminescence to become quenched).

Luminescence is characterized in that the emission of light is not primarily caused by the temperature of the emitting body, as opposed to incandescence where that is the case. Luminescence includes the chemical phenomena of phosphorescence and fluorescence, both of which involve a chemical reaction whereby an atomic (or, more precisely, quantized electron) state of the luminescent substance is excited from a ground energy state to a higher (excited or energized) energy state. This excitation occurs when the luminescent substance is exposed to an activating agent (various examples of which will be discussed later).

In fluorescence, as the atomic state of the luminescent substance drops back from the excited state to the ground state, radiation is emitted in the form of fluorescent light. Typically, the fluorescence persists while the activating agent is supplied, because the luminescent compound is continually re-excited to a higher energy state. Following each excitation, the compound emits a corresponding photon during the fall back to the ground state. If the activating agent is removed, the luminescent substance remains in its ground state, and no more light is emitted.

In phosphorescence, the atomic state of the luminescent substance drops back from the excited state to the ground state over some period of time, so the phosphorescence persists even after the activating agent is removed. The difference (from fluouresence) results from the presence of a metastable, intermediate state between the excited state and the ground state. The fall back to ground state is not a single step process, but must pass through the intermediate state, and then to the ground state. The intermediate state is metastable, and the occurrence of jumps from it to the ground state is probabilistic. So, in any macroscopic physical sample comprised of many molecules, each molecule is in the metastable state. Some of these molecules will drop back to the ground state sooner, and some later. Of course, each of these drops is associated with the emission of a photon, so the overall light emission will occur over an extended time period until all of the molecules' electrons are back in the ground state. Depending on the compound, this time period may be a fraction of a second, seconds, minutes or even hours after the activating agent (i.e., excitation energy) is removed.

II. A Generic Air Writing System

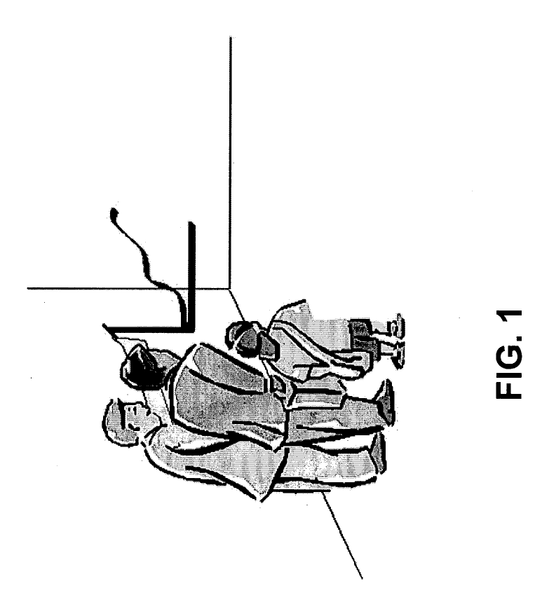

FIG. 1 illustrates an exemplary air writing operation, in which a presenter is drawing a graph in the air using a handheld wand.

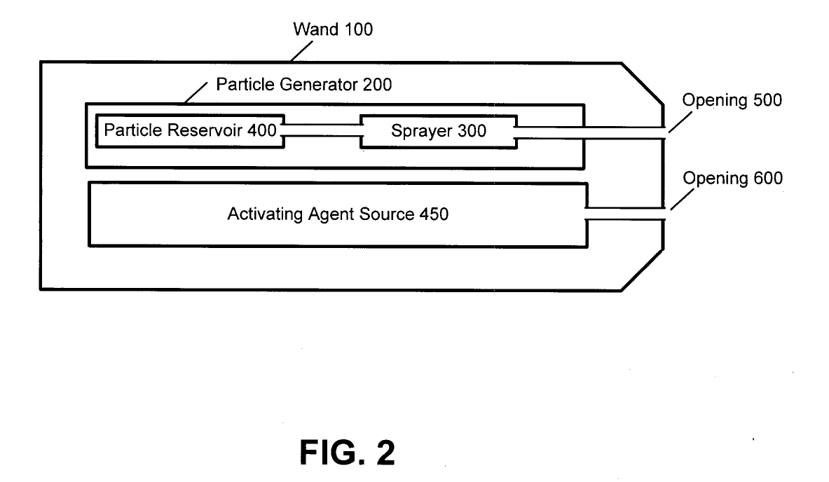

FIG. 2 illustrates schematically an exemplary generic portable air writing system. We have deliberately used a schematic representation to emphasize that the detailed configuration of actual air writing systems is immaterial to the core air writing technologies presented herein. For ease of illustration, we shall depict the system as having a generally wand-shaped external form factor. Nevertheless, even the term “wand” should be understood to include generally any handheld instrument usable by a human being to write in the air, regardless of the degree of elongation, aspect ratio, symmetry, or other external shape factors. Similarly, the internal configuration of the wand is also highly flexible, and virtually any geometric configuration can be used while still remaining within the spirit of the air writing technologies presented herein.

In this illustrative embodiment, a wand 100 includes a luminescent particle generator 200 and a source of activating agent 400.

The particle generator 200 includes a sprayer 300 for creating an airborne, or buoyant, field of luminescent particles, which are supplied by a reservoir 400. The particles are outputted to the air through an opening 500.

The source of activating agent 400 also outputs the activating agent (e.g., photons or a chemical reagent) via opening 600. Exemplary activating agents will be described in greater detail in following sections below. For illustration purposes, the wand 100 depicts two openings, 500, 600. One skilled in the art would readily appreciate that the wand 100 may include more or less openings in accordance with the requirements of a particular implementation.

In one exemplary embodiment, the wand is operable in two modes: (A) a field seeding mode; and (B) a writing mode. In the field seeding mode, the particle generator 200 portion of the wand 100 is activated to create (e.g., seed) a field (e.g., a cloud) of luminescent particles external to the wand.

After the external field is created, the wand is switched to the writing mode, wherein the activating agent is emitted from the wand. As mentioned in the previous section, a chemical reaction between the luminescent particles and the activating agent, causes a change (positive or negative) in luminescence of the particles. The wand is moved by the user, to trace out text, a drawing, or some other form of writing while the activating agent is being emitted. In this fashion, the change in luminescence caused by the chemical reaction appears visible within the field as writing.

For clarity of illustration, we have omitted certain features such as a power source (for either the particle generator 200 and/or the activating agent source 300), a mechanism for selectively switching between seeding mode and writing mode, a switch allowing a user of the wand to selectively operate the wand during an air writing operation, and other incidental details. Each of these could be implemented using well known commercially available components, and need not be described in detail herein. For example, the switch may be implemented so as to be operated via pressure applied externally to the wand.

Also, although FIG. 2 illustrates the wand as containing both particle generator 200 and activating agent source 450, this is not strictly required. The actual choice will be a matter of design implementation, depending on such factors as the desired degree of miniaturization, the desired capacity of particle reservoir 400, the desired weight of the wand, etc. For example, to implement a smaller wand, particle generator 200 could be deployed externally to the wand (e.g., using commercially available technologies such as those found in room fogging devices used in stage productions, nightclubs, etc.).

III. An Exemplary Electromechanical Particle Generator

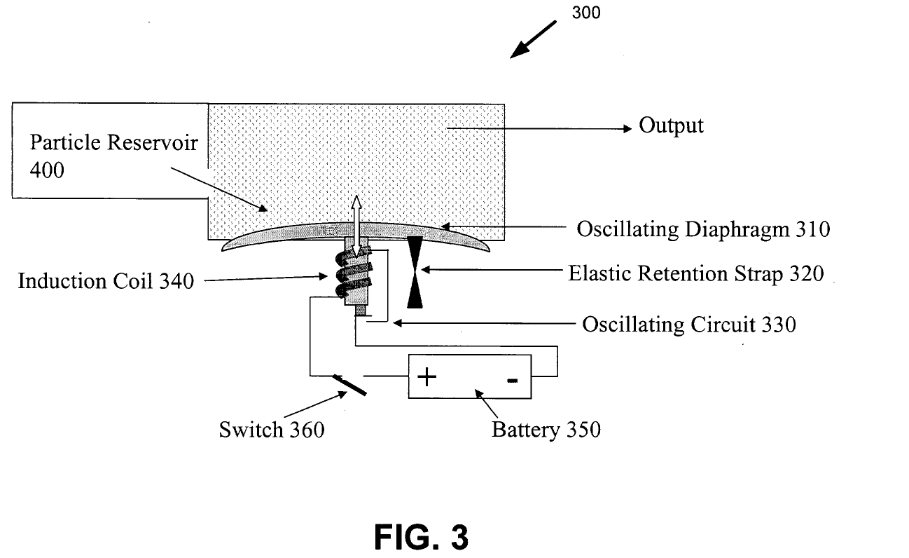

In this section, we present a more detailed description of an exemplary particle generator 200 and, in particular, of an exemplary electromechanical sprayer 300. Referring now to FIG. 3, exemplary sprayer 300 includes an oscillating diaphragm 310 movably anchored by elastic retention strap 320. During operation, diaphragm 310 is caused to oscillate by oscillating circuit 330, including an induction coil 340 powered by a battery 350 and connected to a switch 360.

As current is applied to induction coil 340, it moves upward, causing diaphragm 310 to apply higher pressure to output particles supplied by particle reservoir 400. Then, the current flow is reversed, causing the coil to move downward, creating a lower pressure that draws more particles from reservoir 400. In this fashion, as long as the oscillating circuit 330 is operated, luminescent particles are outputted from sprayer 300 of particle generator 200.

Of course, this embodiment is merely exemplary, and the particle generator can also be implemented using a wide variety of commercially available spraying technologies, all of which should be well understood to those skilled in the art and need not be described in greater detail herein. By way of example, these might include a mechanically operated bellows, a pressurized canister, a liquid-fed aerosol pump, etc.

IV. An Exemplary Air Writing System Using Light as the Activating Agent

The particle generator can be used with a wide variety of luminescent particles. The luminescent particles can be characterized in both physical and chemical terms. The physical composition of the luminescent particles may take the form of finely ground solids, buoyant aerosols, and still other forms as a matter of design choice. The chemical characteristics of the luminescent particles will depend on the characteristics of the activating agent (or vice versa). In this section, we shall consider an exemplary embodiment using light (or photons) as the activating agent.

A. Exemplary Light Sources

Where the activating agent is photonic, exemplary sources of activating agent source 450 could include LEDs, lasers, blacklights, and still other types of light sources known to those skilled in the art of photochemistry. For any given implementation, design considerations of the particular system being deployed (e.g., ambient lighting/darkness of the writing environment, desired degree of luminescence, cost, toxicity, etc.) will determine the combination of light source and luminescent particle to be used. In general, the luminescent particles will be selected to have luminescent properties (e.g., fluorescence, phosphorescense, etc.) matching the particular characteristics (e.g., wavelength, energy, etc.) of the light source (i.e., activating agent source 450).

B. Exemplary Luminescent Particles

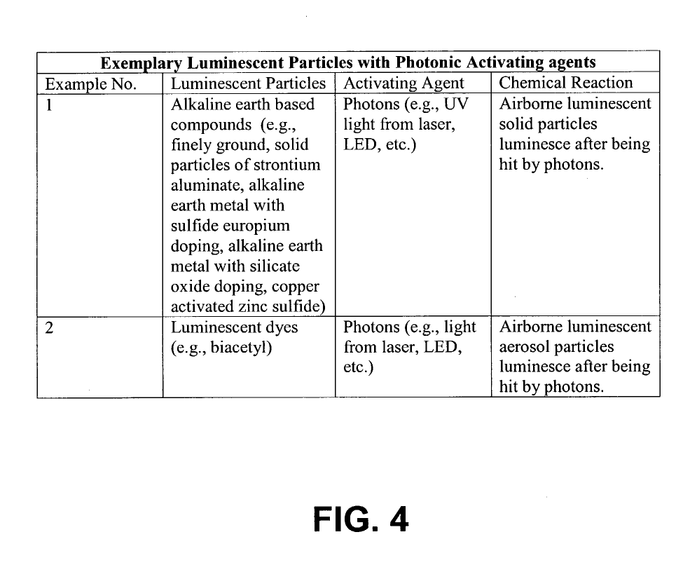

FIG. 4 lists various exemplary substances that can be used to form luminescent particles in solid (e.g., finely ground so as to be essentially buoyant or otherwise airborne) and/or aerosol form.

For example, as shown in example 1 of FIG. 4, these include traditional phosphorescent substances such as zinc sulfide compounds (e.g., copper-activated zinc sulfide, etc.), as well as newer ones such as the alkaline earth metals (e.g., strontium aluminate, other alkaline earth metals with sulfide europium doping, alkaline earth metals with silicate oxide doping, etc.). These kinds of substances will generally phosphoresce when reacting with photons (such as a LED or other light source) emitting light in a wavelength range of approximately 200 and 450 nanometers.

As another example, example 2 of FIG. 4 lists some common exemplary substances that are known to fluoresce. Again, solid and/or aerosol formulations of these substances can be used as luminescent particles. For example, biacetyl (also known as diacetyl or 2-3-butanedione) is a yellowish dye that both fluoresces (as well as phosphoresces) when stimulated by photons across a wide band of wavelengths, and fluorescein is a greenish dye that fluoresces when stimulated by light roughly around 488 nanometers or so. These dyes also have the benefit of being non-toxic, with biacetyl being used as a common food flavoring (as in margarine to impart a buttery taste), and fluorescein being used in angiography and other in vivo procedures in the retina and other parts of the human body.

Still other luminescent substances besides the examples listed in FIG. 4 are well known and commercially available, and need not be described in detail herein.

C. Enhancing Luminescence Via a Light Cavity

In some cases, it may be desirable to enhance the luminescence beyond that provided by simply applying the light to a field of luminescent particles. For example, the luminescence resulting from a particular combination of light source and luminescent particle may not be intense enough to be readily visible to the naked eye. This may result from any of a number of conditions, such as excess ambient light, lack of sufficient seeding density (whether for physical or cost reasons), lack of sufficient illumination (again, whether for physical or cost reasons), and still other factors.

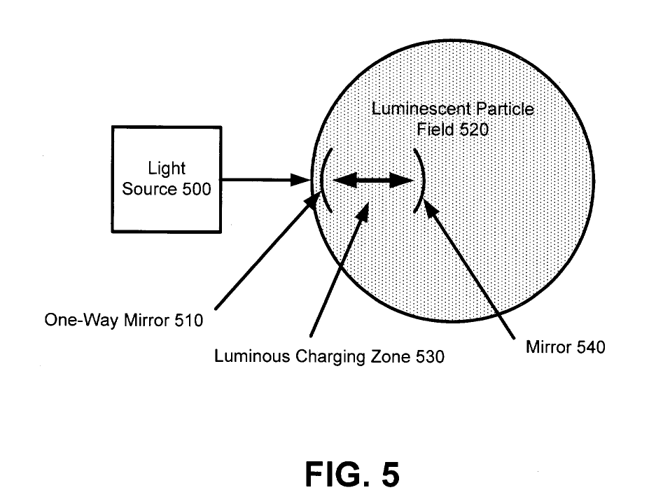

In any of the foregoing cases, or even where it is desired to improve on an already adequate luminescence, the luminescence can be enhanced using the general technique illustrated schematically in FIG. 5. The output from the light source 500 passes (in this depiction, from left to right) through a one-way mirror 510 into the field of luminescent particles 520, thereby causing those of such particles in luminous charging zone 530 to luminesce. However, instead of continuing (to the right) and passing out of the field, the light reflects off another (e.g., conventional) mirror 540, which reflects the light back (to the left). The reflected light again passes through luminous charging zone 530, causing even more of the luminescent particles therein to luminesce. At one-way mirror 510, the light is again turned (to the right), and the process repeats itself. With each such passage of the light through the field, the luminescence is enhanced in luminous charging zone 530.

For ease of illustration, the structural connections between mirror 540 and one-way mirror 510 (or wand 100) have been omitted; any desired structural connection may be used, so long as the space between the mirrors is accessible to the particles in luminous charging zone 530. We shall refer to any region capturing (or at least partially trapping) a light source to provide enhanced illumination as a light cavity. Those skilled in the art will appreciate that light cavities may be implemented in a variety of other ways (besides the exemplary combination of mirrors set forth above) using alternative techniques and structures well known to those in the field of optical engineering.

The use of a light cavity for enhanced luminescence is useful not only for phosphorescence (in which the luminescence would typically have persisted for some time beyond removal of the light source, even if the light had not been captured in the cavity), but is also especially useful to enhance fluorescence (in which the luminescence typically would otherwise have dimmed relatively quickly—compared to phosphorescence—after removal of the light source).

V. An Exemplary Chemiluminescent Air Writing System

In this section, we describe another exemplary air writing system using chemiluminescent particles, together with corresponding chemiluminescent agents as the agent for activating the luminescence. The chemiluminescent agent is a chemical agent rather than a photonic agent as in the previous section. That is, the energy for causing the chemical reaction at the luminescent particles, and exciting them to a higher energy state from which luminescence can occur, is provided by a chemical agent rather than by light. In these situation, the activating agent may be provided using any of the particle generator technologies disclosed above with respect to luminescent particles.

Chemiluminescent substances are well known in the art, and are widely commercially available. We shall provide examples of their use in an air writing system, with reference to two common chemiluminescent substances which heretofore have not been used in an air writing system: (1) the substances found in the Cyalume glow stick, a novelty toy originally developed, manufactured and sold by American Cyanamid Corporation; and (2) the luciferin-luciferase-ATP chemiluminescence that forms the basis of the bioluminescence exhibited by the common firefly, and which has been used in many applications for laboratory biochemistry.

1. Glow Stick Chemistry

The well-known Cyalume glow stick is a plastic tube, about 6 inches long, containing phenyl oxalate liquid surrounding a glass vial. Inside the glass vial is a hydrogen peroxide solution, plus a fluorescent dye. To activate the glow stick, one bends the plastic tube to break the glass vial, and shakes the plastic tube to mix the phenyl oxalate and the hydrogen peroxide. The resulting chemical reaction (i.e., oxidation of phenyl oxalate by hydrogen peroxide) produces energy which causes high energy state from which light is emitted as phosphorescence. The phosphorescent light, in turn, triggers fluorescence from the fluorescent dye, which is typically a bright, yellow-green light.

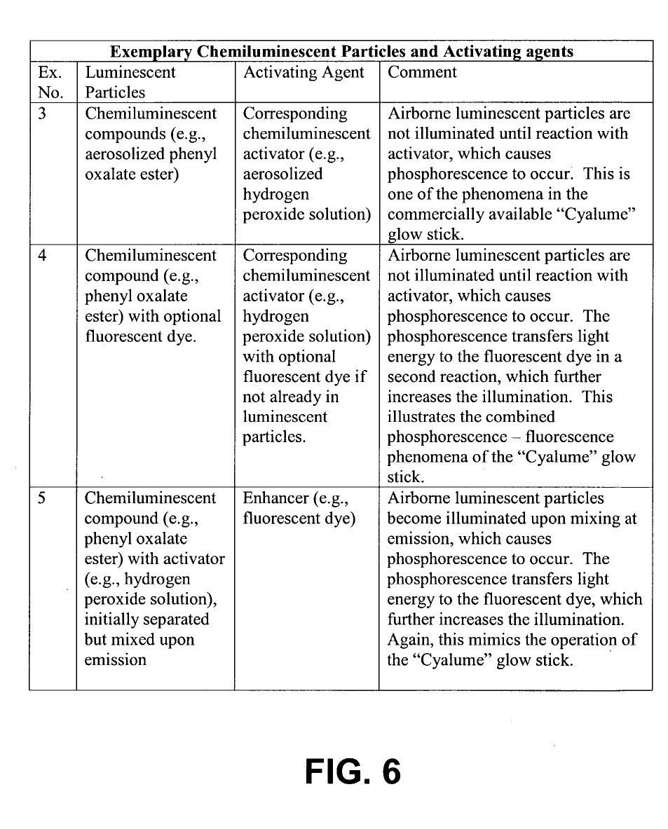

Therefore, the chemistry of the Cyalume nightstick shows that a combination of phenyl oxalate and hydrogen peroxide is sufficient to produce some degree of chemiluminescence. As adapted to the air writing system, an aerosol of phenyl oxalate may form the luminescent particles, and an aerosol of the hydrogen peroxide may form the activating agent. When the latter comes into contact with the former, phosphorescence is produced, and can be used for air writing. This is shown in example 3 in FIG. 6.

Of course (not shown in FIG. 6), the roles of the phenyl oxalate and the hydrogen peroxide could be reversed, with the former being used as the activating agent and the latter as the luminescent particle.

Example 4 in FIG. 6 illustrates another exemplary embodiment, in which the fluorescent dye is added to either the luminescent particles (e.g., phenyl oxalate) or the activating agent (e.g., hydrogen peroxide). When the latter comes into contact with the former, phosphorescence is produced, triggering a fluorescence that can be used for air writing. This is similar to the chemical phenomenon of the Cyalume glow stick.

As in the previous example (but not shown in FIG. 6) the roles of the phenyl oxalate and the hydrogen peroxide could again be reversed.

Example 5 in FIG. 6 illustrates another exemplary embodiment, in which both phenyl oxalate and hydrogen peroxide are used as the luminescent particles. In this case, the two should be stored in separate reservoirs in the wand prior to being emitted, to prevent their reaction from occurring before the wand is used. The two compounds would then be mixed substantially upon being emitted by the particle generator. This would entail a simple modification of the basic wand configuration shown in FIG. 2, which will be well understood by those skilled in the art and need not be described in detail herein. As the mixed compounds leave the wand, then, they will begin to phosphoresce, and can be used to seed the writing field. Then, the activating agent is emitted in the form of the fluorescent dye, which causes a chemical reaction with the phosphorescing luminescent particles that results in an intensified light emission via fluorescence. Again, this is the basic chemistry of the Cyalume glow stick but applied to the new application of air writing.

2. Firefly Chemistry

Still other well known examples of chemiluminescence involve chemistries that originate from living organisms (also known as bioluminescence). One of the most well known of these is the so-called firefly luminescence. Fireflies have a lantern that emits a bright yellowish-white light. This phenomenon is known to result from the oxidation of a compound called luciferin, in the presence of oxygen (the oxidizer) and two enzymatic catalysts, one called luciferase and another adenosine triphosphate (ATP) which is found in living organisms.

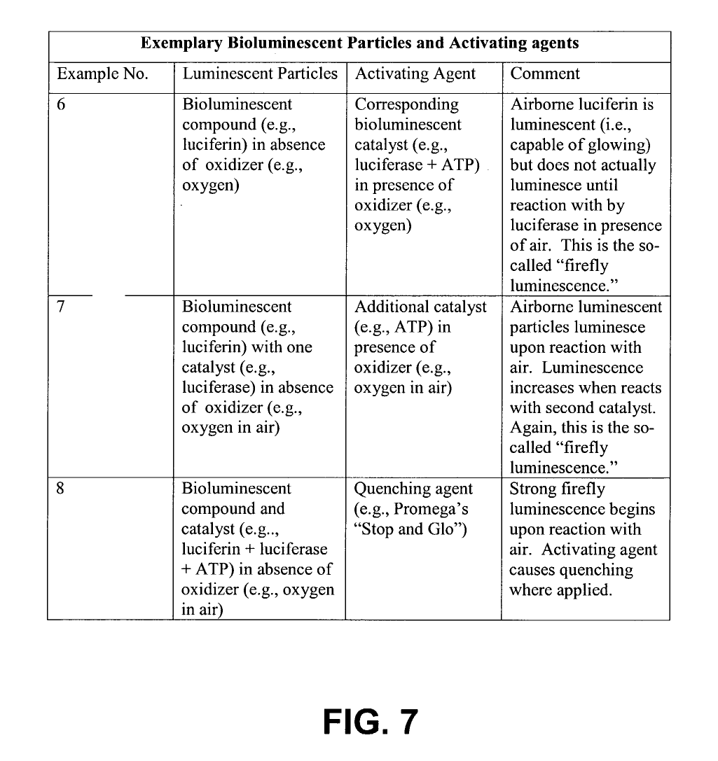

Referring now to FIG. 7, we shall illustrate some exemplary uses of this chemistry in an air writing system.

For example, aerosolized lucifein could be used as the luminescent particle, and the aerosolized catalysts (luciferase and ATP) could be used as the activating agent. This is shown as example 6 in FIG. 7. Of course, to prevent premature oxidation of the luciferin in the wand, it may be desirable to store the luciferin in such a manner as to be isolated from air (i.e., oxygen). This would entail a simple modification of the basic wand configuration shown in FIG. 2, which will be well understood by those skilled in the art.

Of course (not shown in FIG. 7), the roles of the luciferin and the catalysts could be reversed, with the former being used as the activating agent and the latter as the luminescent particle.

In addition, the catalysts need not be together. Example 7 in FIG. 7 illustrates another exemplary embodiment, in which one of the catalysts is added to the luciferin to form the luminescent particles, and the other catalyst is used as the activating agent.

As in the previous example (but not shown in FIG. 7) the roles of the luciferin and the catalyst(s) could again be reversed.

3. Other Chemiluminescent Embodiments

The Cyalume glow stick and luciferin-luciferase chemistries are perhaps the most well know in the field of chemiluminescence. Those skilled in the art will readily appreciate that many other chemical combinations may also be used with the air writing system described herein. Indeed, where the luminescent particles and the activating agent are both chemicals, the luminescent particles and activating agents may be interchanged. That is, a chemical illustrated as a luminescent particle can be used as an activating agent, and a chemical illustrated as an activating agent can be used as a luminescent particle. In yet another implementation, the activating agent could be sprayed into the air (e.g., using any of the particle generator technologies disclosed above for luminescent particles), and the luminescent particles introduced into the field thus formed to cause luminescence.

VI. An Exemplary Chemiluminescent Air Writing System With Quenching

In all the foregoing, the chemical reaction between the luminescent particles and the activating agent (whether photons or a chemical) caused the production and/or intensification of light. Thus, in either case, the writing appeared as brighter regions in an initially darker field. However, the reverse is also possible. That is, it is possible to implement air writing that appears as darken regions in an initially lighter field.

In particular, suppose that all the elements of the firefly luminescence are stored (separately) in the particle generator and aerosolized to create a luminescing field upon emission from the wand. This would form a bright field within which writing could occur, if the phosphorescence could be selectively extinguished upon emission of the activating agent from the wand. Such an activating agent would, of course, activate a chemical reaction that functions to quench the luminance of the luminescent particles. Such quenching can be achieved using commercially available quenching agents particular to the luminescent reaction.

More specifically, it is well known that luminescence processes (e.g., fluorescence and phosphorescence) can be quenched by collision of the excited molecules with other molecules, which absorb the excess energy. The quenching agent(s) to be used in any particular implementation is typically specific to a particular luminescent substance, but are generally well known from the scientific literature as well as commercially available. For example, Promega Corporation currently manufactures and sells a quenching agent called Stop and Glo for use with firefly (luciferin-luciferase) luminescence.

Example 8 of FIG. 7 shows the use of luciferin-luciferase-ATP being mixed and aerosolized just as they leave the wand. The luminescent particles so produced would phosphoresce with firefly luminescence. Then, Stop and Glo can be used as an activating agent to initiate a chemical reaction (basically, causing energy-sapping collisions with the excited molecules of) the firefly luminescence to quench its phosphorescence. By emitting the quenching agent from the wand during an air writing operation, the writing that is produced will appear dark-on-light.

VII. Triggering Luminescence Inside the Wand

In many of the foregoing examples, the luminescent particles were outputted from the wand to form an external buoyant or airborne field, then caused to undergo a chemical reaction outside the wand, to change their luminance (or luminescence or intensity). Basically, one first seeds the field, then moves the wand through the field to change some of the particles' intensity (whether intensifying or quenching) during the air writing. This may be regarded as first creating a cloud of particles, then using that field as a slate or background on which to write.

Alternatively, those skilled in the art will readily appreciate that the field could be generated, and the luminance-changing chemical reaction caused to occur, (at least partially) inside the wand. Thereafter, the particles would be outputted from the wand in a light writing operation.

VIII. Conclusion

The foregoing examples illustrate certain exemplary embodiments from which other embodiments, variations, and modifications will be apparent to those skilled in the art. The inventions should therefore not be limited to the particular embodiments discussed above, but rather are defined by the claims.

What is claimed is:

1. An air writing system, comprising:
(a) a particle seeding subsystem, including:
(i) a reservoir of luminescent particles;
(ii) a sprayer configured to access said luminescent particles in said reservoir to create a buoyant field of said luminescent particles; and
(b) a source of activating agent for changing a luminance of some of said luminescent particles within said buoyant field by causing a chemical reaction;
(c) a handheld wand for writing in said field, including
(i) an opening in said wand for outputting at least one of said luminescent particles and said activating agent while said wand is being moved in a spatial pattern by a holder thereof; and
(ii) a user-operable switch for selectively controlling said outputting of said particles.

2. The air writing system of claim 1 where:
(i) said activating agent includes photons of light;
(ii) said luminescent particles include particles that phosphoresce under said light; and
(iii) said chemical reaction includes photon-induced state changes resulting in light emission in the visible range.

3. The air writing system of claim 1 where:
(i) said source of said activating agent for causing a chemical reaction includes a light source having at least one characteristic wavelength; and
(ii) said luminescent particles luminesce under said characteristic wavelength.

4. The air writing system of claim 3 where said wand includes a light cavity configured to at least partially trap light about said luminescent particles.

5. The air writing system of claim 3 where said light source includes a LED.

6. The air writing system of claim 3 where said light source emits ultraviolet light.

7. The air writing system of claim 1 where:
(i) said activating agent includes a quenching agent;
(ii) said luminescent particles have a luminescence that is quenchable by said quenching agent; and
(iii) said chemical reaction includes quenching said luminescence.

8. The air writing system of claim 7 where said luminescence includes fluorescence.

9. The air writing system of claim 1 where said particle seeding subsystem is part of said wand.

10. The air writing system of claim 1 where said particle seeding subsystem is external to said wand.

11. The air writing system of claim 1 where said luminescent particles include aerosols.

12. The air writing system of claim 1 where said luminescent particles include solids.

13. The air writing system of claim 1 where said luminescent particles include alkaline earth metal compounds.

14. The air writing system of claim 1 where:
(i) said buoyant field initially occurs inside said wand; and
(ii) said changing said luminance includes causing said particles to luminesce prior to said outputting.

15. The air writing system of claim 1 where:
(i) said buoyant field occurs outside said wand; and
(ii) said changing said luminance occurs after said outputting.

16. The air writing system of claim 1 where said outputting is of said luminescent particles.

17. The air writing system of claim 1 where said outputting is of said activating agent.

18. An air writing system, comprising:
(a) a particle generator configured to create an airborne field of luminescent particles;
(b) a source of activating agent for changing a luminance of some of said luminescent particles by causing a chemical reaction; and
(c) a handheld wand for writing in said field, including an opening for outputting a stream of said luminescent particles while said wand is being moved in a spatial manner by an air writer.

19. The air writing system of claim 18 where:
(i) said activating agent includes photons of light;
(ii) said luminescent particles include particles that phosphoresce under said light; and
(iii) said chemical reaction includes photon-induced transition state changes resulting in light emission in the visible range.

20. The air writing system of claim 19 further comprising a switch configured to selectively provide said photons.

21. The air writing system of claim 19 where said photons are in the ultraviolet range.

22. The air writing system of claim 18 where:
(i) said activating agent includes a quenching agent;
(ii) said luminescent particles have a luminescence that can be quenched by said quenching agent; and
(iii) said chemical reaction includes quenching said luminescence.

23. The air writing system of claim 22 where said luminescence includes fluorescence.

24. The air writing system of claim 18 where said luminescent particles include alkaline earth metal compounds.

25. The air writing system of claim 18 where:
(i) said buoyant field initially occurs inside said wand; and
(ii) said changing said luminance includes causing said luminescent particles to luminesce prior to said outputting.

26. The air writing system of claim 18 where:
(i) said buoyant field occurs outside said wand; and
(ii) said changing said luminance occurs after said outputting.

27. The air writing system of claim 18 where said wand includes a light cavity configured to at least partially trap light about said luminescent particles.

28. The air writing system of claim 18 where said chemical reaction produces fluorescence.

29. An air writing system, comprising:
(a) means for creating an airborne field of luminescent particles; and
(b) means for changing a visual intensity of at least some of airborne luminescent particles within said field by pointing a wand at said airborne luminescent particles during an air writing operation.

30. The air writing system of claim 29, where:
(i) said airborne luminescent particles are not initially illuminated; and
(ii) said (b) includes means for exciting said non-illuminated luminescent particles to a higher energy state, resulting in radiation emission upon returning to a lower energy state.

31. The air writing system of claim 29, where:
(i) at least a portion of said airborne field is illuminated after said creation; and
(ii) said (b) includes means for selectively quenching some of said illuminated luminescent particles during an air-writing operation.

32. A method for air writing, comprising:
(a) creating an airborne field of luminescent particles by using a particle generator connected to a reservoir containing luminescent particles; and
(b) tracing a visible path through said field by using a wand that changes an intensity of at least some of said airborne luminescent particles by causing a chemical reaction at said at least some airborne luminescent particles.

33. The method for air writing of claim 32 where:
(i) said wand includes a light source to excite said luminescent particles; and
(iii) said chemical reaction includes photon-induced transition state changes resulting in light emission in the visible range.

34. The method for air writing of claim 33 further comprising selectively operating said wand corresponding to an air writing operation.

35. The air writing method of claim 32 where:
(i) said creating said airborne field includes causing said luminescent particles to exhibit luminescence;
(ii) said chemical reaction includes quenching said luminescence; and
(iii) said luminescent particles have a luminescence that can be quenched by said quenching.

36. The method for air writing of claim 35 where said luminescence includes fluorescence.

37. The method for air writing of claim 32 where:
(i) said (a) includes creating said airborne field initially inside said wand; and
(ii) said (b) includes causing said luminescent particles to luminesce while inside said wand.

38. The method for air writing of claim 32 where:
(i) said (a) includes creating said airborne field outside said wand; and
(ii) said (b) includes causing said luminescent particles to luminesce outside said wand.

39. The method for air writing of claim 32 further comprising, after at least said (a), enhancing a luminescence of at least some of said airborne luminescent particles by trapping light thereabout.

40. A handheld wand, comprising:
(a) a particle generator configured to create an airborne field of luminescent particles;
(b) a source of activating agent for changing a luminance of some of said luminescent particles by causing a chemical reaction; and
(c) an opening for outputting a stream of said luminescent particles while said wand is being moved in a spatial manner by a user.
